(19) United States
(12) Patent Application Publication
(10) Pub. No.: US 2012/0218321 A1
(43) Pub. Date: Aug. 30, 2012

(54) IMAGE DISPLAY SYSTEM

(76) Inventors: Yasunori Ake, Osaka-shi (JP); Kazuyuki Kishimoto, Osaka-shi (JP)

(21) Appl. No.: 13/497,802

(22) PCT Filed: Aug. 3, 2010
(86) PCT No.: PCT/JP10/63110

§ 371 Date: Mar. 23, 2012

(30) Foreign Application Priority Data
Nov. 19, 2009 (JP) 2009-264206

(51) Int. Cl. G09G 5/10

(52) U.S. Cl. 345/690

(57) ABSTRACT

The present invention provides an image display device capable of maintaining appropriate display luminance for human visual properties. The image display device of the present invention includes: a display device main body (20) having a display section (21) and a light source (24); and viewing means (glasses (10)) that a viewer is able to wear in viewing a video picture displayed on the display section (21). The viewing means (10) includes (i) a light reception detecting section (13) that detects the intensity of incident light (ii) and a signal transmitting section (14) that transmits, to the display device main body (20), detection signals obtained by the light reception detecting section (13) detecting the intensity of the incident light. The display device main body (20) includes a luminance control section (23) that controls the luminance of the display section (21) by controlling the luminance of the light source (24) in accordance with the detection signals.

### TECHNICAL FIELD

The present invention relates to an image display system that can appropriately control the brightness (luminance) of a display screen according to visual properties.

### BACKGROUND ART

Conventionally, image display devices have been widely used for displaying images on television receivers, computer devices, etc. An image display device typically has such a problem that the brightness of a display screen needs to be adjusted every time the display screen becomes relatively too bright or too dark as a result of a change in indoor brightness. Thus, a technology has been developed which measures brightness around a viewer with a brightness sensor (light reception detecting section) and then adjusts the brightness (luminance) of a display screen accordingly. That is, the brightness sensor is mounted on a main body of an image display device to detect the brightness around the viewer, and to control the brightness of the display screen according to the information.

Failure of the brightness sensor to appropriately control the brightness of the display screen brings such discomfort to the viewer as a feeling that “the display is too bright” or “the display is too dark”. Also, displaying an image with more brightness than necessary creates problems such as visual fatigue and an increase in power consumption.

Conventionally, as shown in FIG. 7, such a brightness sensor has been installed in a place such as an area around a display screen of an image display device main body 40. Thus, in the conventional example shown in FIG. 7, a brightness sensor 41 is provided on the same surface as the display screen so that the brightness of the display screen is controlled in accordance with an intensity of light received by the brightness sensor 41.

Normally, in a case where a viewer looks at a display screen of an image display device, light from behind the display screen (background light) comes into the viewer's sight, along with light from the display screen. By appropriately adjusting the brightness of the display screen in relation to the brightness of the background light, it is possible to reduce the discomfort caused by the display screen being too bright or too dark. That is, what actually matters in a viewing experience is information about the brightness of a display screen and brightness therearound. However, in the conventional example shown in FIG. 7, the brightness sensor 41, provided on the same flat surface as the display screen, receives only light incident on the display screen. This makes it difficult to properly detect the brightness of light incident on the eyes of the viewer (background luminance) from the display screen and from an area around the display screen.

Further, there is also a case where due to a difference between an environment in which the image display device is placed and the location of the viewer, the brightness sensor is unable to properly measure a viewing environment in which the viewer is. Therefore, the conventional technology is unable to properly adjust the brightness of the display screen, and therefore unable to solve the problem of discomfort caused by the display being too bright or too dark.

In view of this, Patent Literature 1 suggests such a configuration as that shown in FIG. 8 to prevent a decrease in precision of control of brightness adjustment according to outside illuminance. Such a decrease occurs because, depending on the position of an illuminance sensor (brightness sensor), the resulting output is different from the brightness of the viewing environment (outside illuminance).

As shown in FIG. 8, a display device 5 includes: a first illuminance sensor 502, provided on a display device main body 50, which measures the outside illuminance of a displaying environment on the side of a display panel 501; and a second illuminance sensor 511, provided in a place further away from the display panel 501 than the first illuminance sensor 502, e.g., in a remote controller 51 that a user has close at hand in a viewing environment, which measures outside illuminance in the viewing environment. Moreover, a control section 503 provided in the display device main body 50 controls a light intensity of a backlight 501A of the display panel 501 in accordance with illuminance signals from the first and second illuminance sensors 502 and 511.

That is, the control section controls the luminance of the display device with the average value or the weighted average value of (i) first outside illuminance measured by the first illuminance sensor and (ii) second outside illuminance measured by the second illuminance sensor.

### CITATION LIST

### Patent Literature 1

Japanese Patent Application Publication, Tokukai, No. 2006-72255 A (Publication Date: Mar. 16, 2006)

### SUMMARY OF INVENTION

### Technical Problem

However, in view of the place in which an image display device is usually put, it is impossible to properly measure display luminance simply by, as in Patent Literature 1, providing illuminance sensors both in an image display device main body and a remote controller and averaging the illuminance (brightness) measured by each illuminance sensor.

Further, Patent Literature 1 discloses an example in which a filter and a phototransistor are combined to be used as an illuminance sensor. However, an illuminance sensor configured as such merely measures an averaged light intensity in consideration solely of a difference between the environment in which the display device main body is located and the environment in which the remote controller is located (normally the viewer has it close at hand), but not of a spatial distribution of light. As such, the illuminance sensor cannot properly measure field luminance. That is, because it is impossible to select light from a particular direction and measure the intensity (illuminance) of the light, it is impossible to accurately measure the brightness of the viewing environment in which the viewer is.

The present invention is made in view of such conventional problems, and it is an object of the present invention to provide an image display system capable of controlling display luminance appropriately for the visual properties of a viewer.

### Solution to Problem

In order to solve the foregoing problems, an image display system according to the present invention includes: a display device main body having a display section and a light source that irradiates the display section with light; and viewing means that a viewer is able to wear in viewing a video picture displayed on the display section, the viewing means including (i) a light reception detecting section that detects an intensity of incident light and (ii) a signal transmitting section that transmits, to the display device main body, detection signals obtained by the light reception detecting section detecting the intensity of the incident light, the display device main body including a luminance control section that controls a luminance of the light source in accordance with the detection signals.

The foregoing configuration has the light reception detecting section included in the viewing means. Therefore, simply by the viewer wearing the viewing means and viewing the video picture displayed on the display section of the display device main body, the intensity of the light incident on the viewing means is detected, so that the detection signals thus obtained can be transmitted to the display device main body. Further, by controlling the luminance of the light source in accordance with the detection signals thus transmitted, the display device main body can appropriately control the display luminance of the display section. That is, the detection of the light intensity of a viewing environment can be carried out from a viewer's end, whereby the display luminance can be maintained appropriately for human visual properties. Therefore, unlike in the case of the conventional technologies, the viewer is less likely to experience such discomfort as a feeling that the display section is too bright or too dark to look at, so that a reduction in the viewer's visual fatigue can be achieved. Furthermore, the light source does not become higher in luminance than necessary, so that a reduction in power consumption can be achieved.

### Advantageous Effects of Invention

As described above, the present invention can achieve an image display system capable of maintaining appropriate display luminance for human visual properties.

### BRIEF DESCRIPTION OF DRAWINGS

FIG. 1 is a block diagram showing a configuration of a main part of an image display system according to an embodiment of the present invention.

FIG. 2 is a diagram showing the appearance of a viewer looking at a display device main body with glasses (viewing means) of the image display system shown in FIG. 1.

FIG. 3 is a diagram showing an example of an image of light received by an image sensor provided the glasses (viewing means) constituting the embodiment of the present invention.

FIG. 4 is a set of schematic views (a) and (b), (a) showing a configuration of the image sensor provided in the glasses (viewing means) constituting the embodiment of the present invention, (b) showing a relationship between each pixel of the image sensor and an angle of incidence of incident light.

FIG. 5 is a diagram showing the visual properties of the viewer according to the embodiment of the present invention.

FIG. 6 is a diagram showing a relationship of light source output (light emission luminance) with respect to adaptation luminance according to the embodiment of the present invention.

FIG. 7 is a diagram showing reception of light by a brightness sensor provided on a display device main body according to a conventional technology.

FIG. 8 is a block diagram showing a configuration of a main part of an image display device according to a conventional technology.

FIG. 9 is a diagram explaining a method for calculating a distance from the viewing means (viewer) to the display device main body during use of the image display system according the embodiment of the present invention.

FIG. 10 is a diagram showing the appearance of a viewer looking at a display device main body with glasses (viewing means) according to another embodiment of the present invention.

FIG. 11 is a block diagram showing a configuration of a main part of an image display system according to another embodiment of the present invention.

### DESCRIPTION OF EMBODIMENTS

Embodiments of the present invention are described below with reference to the drawings. It should be noted that the present invention and the scope thereof are not to be limited to the embodiments. The embodiments are merely explanatory examples.

An image display system of the present invention includes a display device main body and viewing means which a viewer can wear in viewing a video picture on the display device main body. The viewing means receives light from the display device main body and from the area around the display device main body, detects the intensity (brightness) of the light so as to generate detection signals, and transmits the detection signals (information about the intensity of the light) to the display device main body. Meanwhile, the display device main body receives the information from the viewing means, measures the luminance of the light received by the viewing means, and controls the luminance of its light source in accordance with the luminance thus measured. This makes it possible to control display luminance appropriately for the viewing environment and the visual properties of the viewer.

### Embodiment 1

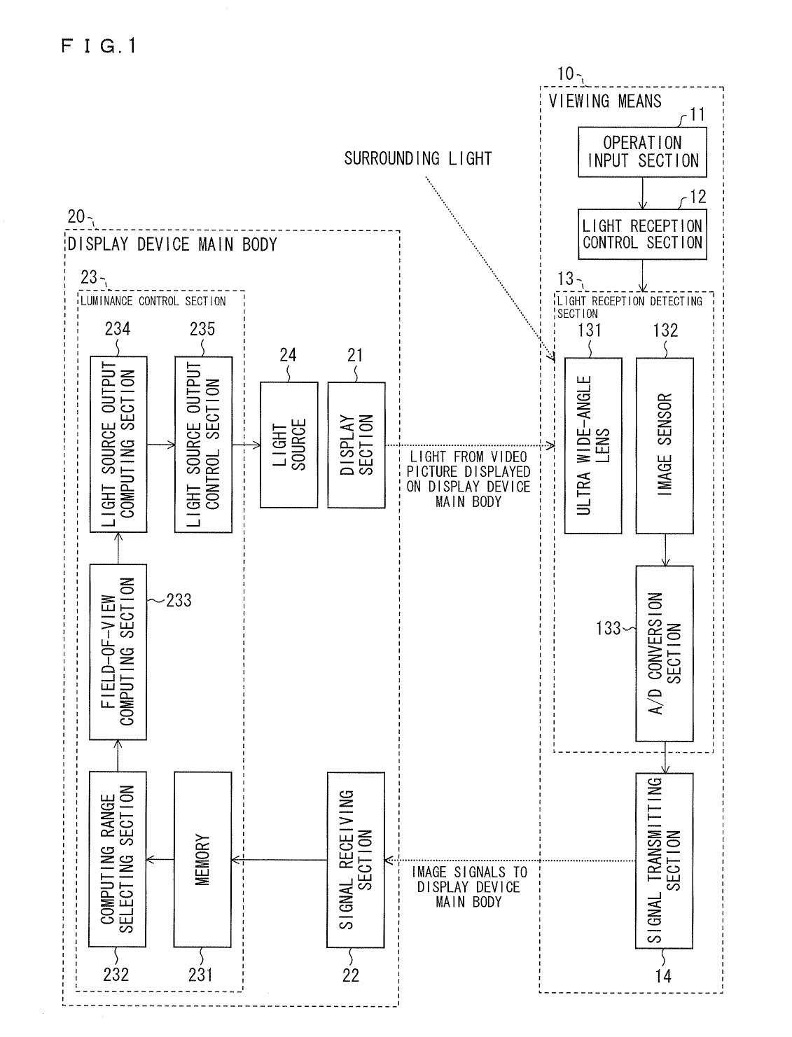

FIG. 1 is a block diagram showing a configuration of a main part of an image display system according to an embodiment of the present invention. The present embodiment describes, as an example of the present invention, a case where the display device main body is a thin-shaped television receiver including a liquid crystal panel, and where the viewing means is glasses which can be worn in viewing a video picture on the liquid crystal panel.

As shown in FIG. 1, the image display device of the present invention includes glasses 10 and a display device main body 20.

The glasses 10 include: an operation input section 11, which decides, upon a viewer's operation, whether or not to detect the intensity of light from the display device main body 20 and from an area around the display device main body 20; a light reception control section 12, which, if the operation input section 11 decides to detect the intensity of the light, gives an instruction to detect received light; a light reception detecting section 13, which receives an instruction to start detection from the light reception control section 12, which receives the light from the display device main body 20 and from the area around the display device main body 20, and which detects the intensity of the light received; and a signal transmitting section 14, which transmits, to the display device main body 20, a detection result of the light intensity received from the light reception detecting section 13.

It should be noted here that the operation input section 11 is used by the viewer to choose to start detection of the intensity of light; it is upon the viewer's operation that control of the surface luminance of the display device main body 20 is started. That is, by providing the operation input section 11 in the glasses 10 which the viewer can wear, the viewer is allowed to decide, according to his/her need, whether or not to detect the intensity of light from the surrounding area, and to selectively and control the surface luminance of the display device main body 20 appropriately for the viewer.

Further, the light reception detecting section 13 of the glasses 10 includes a light-receiving lens and a sensor member in order to receive light from the display device main body 20 and the surrounding area and to detect the intensity of the light. Described below is a case where the light-receiving lens used is an ultra wide-angle lens, such as a fish-eye lens, and the sensor member used is an image sensor 132, such as a CMOS or a CCD. Of course, this is merely an example of the embodiment of the present invention, and the light reception detecting section is not particularly limited in configuration as long as the light reception detecting section is configured to receive light from the direction of the display device main body 20 and detect the intensity of the light.

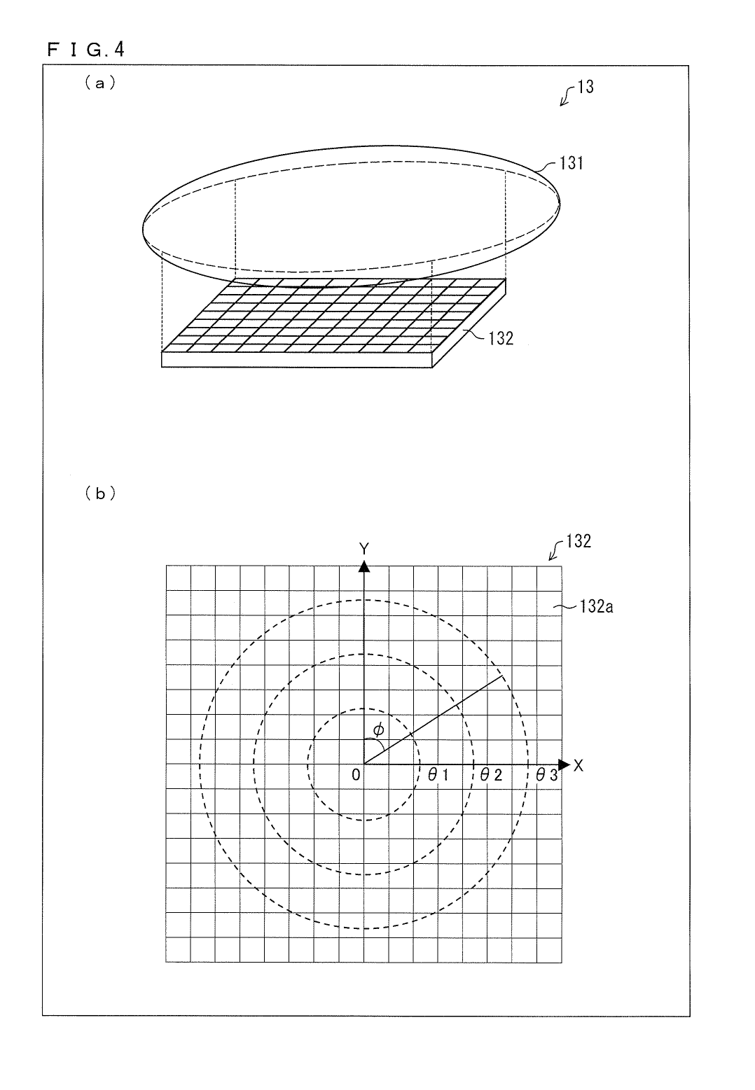

(a) of FIG. 4 shows an example of the configuration of the light reception detecting section 13 having the ultra wide-angle lens 131 and the image sensor 132.

As shown in (a) of FIG. 4, when the light reception detecting section 13 includes the ultra wide-angle lens (fish-eye lens) 131 and the image sensor (CMOS or CCD) 132, the ultra wide-angle lens 131 can receive surrounding light from an angle of view of 180 degree. Then, the image sensor 132 can detect light intensity for each direction from which light is incident. Since the image sensor 132, which has a two-dimensional arrangement of pixels, can detect the intensity of incident light for each of the pixels, the image sensor 132 can capture received light as a two-dimensional image. That is, in the image sensor 132 outputs, from each of the pixels, a signal corresponding to the intensity of the incident light. It should be noted that, since the system under which the image sensor detects the intensity of incident light has conventionally been well known, and as such, is not described here.

Further, the light reception detecting section 13 includes an A/D conversion section 133. The A/D conversion section 133 converts signals outputted from the respective pixels of the image sensor 132 into digital signals. The digital signals are then transmitted as detection signals to the display device main body 20 by the signal transmitting section 14. It should be noted that since, in the present embodiment, the detection signals are generated by the image sensor 132, the detection signals can also be called image signals (signals containing information about the intensity of received light corresponding to each pixel).

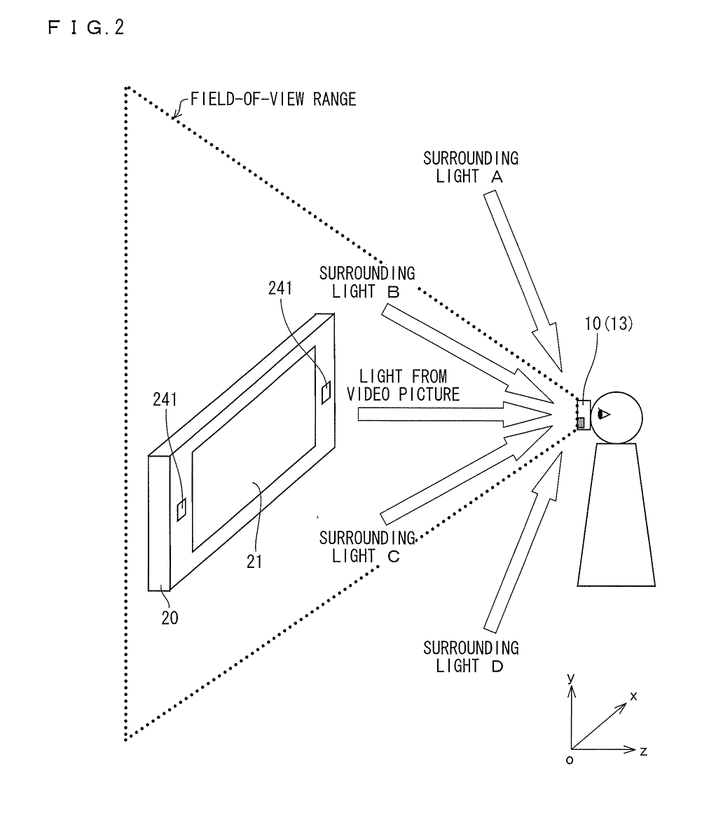

FIG. 2 is a diagram showing the way in which light (hereinafter referred to as “light incident on the glasses 10”) from the display device main body 20 and from the area around the display device main body 20 enters the glasses 10 worn by the viewer. Since the glasses 10 include the ultra wide-angle lens 131, the glasses 10 can, for example, receive light from an angle of view of 180 degrees, such as surrounding lights A-D, in addition to light from the video picture on the display device main body 20.

In FIG. 2, a triangular range defined by dotted lines is the viewer's field-of-view range. That means that because the surrounding lights A and D, which enter from outside of the field-of-view range, cannot be perceived by the viewer, the surrounding lights A and D are lights (unnecessary light) that do not affect the visual properties of the viewer.

In view of this, in the present embodiment, based on the assumption that only the light from the display device main body 20 and the surrounding lights B and C are lights (necessary light) that affect the visual properties of the viewer, the display device main body 20 is configured to control the luminance of a light source 24 in consideration solely of the intensity of received light corresponding to the range of necessary light.

This is achieved by configuring the light reception detecting section 13 provided in the glasses 10 to not only merely detect the intensity of the incident light but also generates, as detection signals, information associating the angle of incidence of the incident light and the intensity of light at the angle of incidence with each other. More specifically, the light reception detecting section 13 is configured to recognize the angle of incidence of the incident light in accordance with the coordinates of each of the pixels of the image sensor 132. The point is described below with reference to FIGS. 2 through 4.

Let it be assumed in FIG. 2, that the position of a principal point of the glasses 10 (position of an optical axis of the ultra wide-angle lens 131) is an origin O and that with respect to the origin O, the glasses 10 has its horizontal direction extending along an X axis, its vertical direction extending along a Y axis, and its depth direction (optical axis of the ultra wide-angle lens 131) extending along a Z axis. Further, let it be assumed that the angle between the Y axis and any given line on a plane formed by the X axis and the Y axis is an angle of direction φ and the angle between the Z axis and any given line on the plane is a polar angle θ. The angle of incidence of incident light is defined by the angle of direction φ and the polar angle θ.

(b) of FIG. 4 is a diagram showing a relationship between each pixel of the image sensor 132 and the angle of incidence (the angle of direction φ and the polar angle θ) of incident light. Each square in the diagram represents each pixel of the image sensor 132. Also, the X and Y axes shown in (b) of FIG. 4 correspond to the X and Y axes of FIG. 2, respectively. Further, θ1 is 30 degrees, θ2 is 60 degrees, and θ3 is 90 degrees.

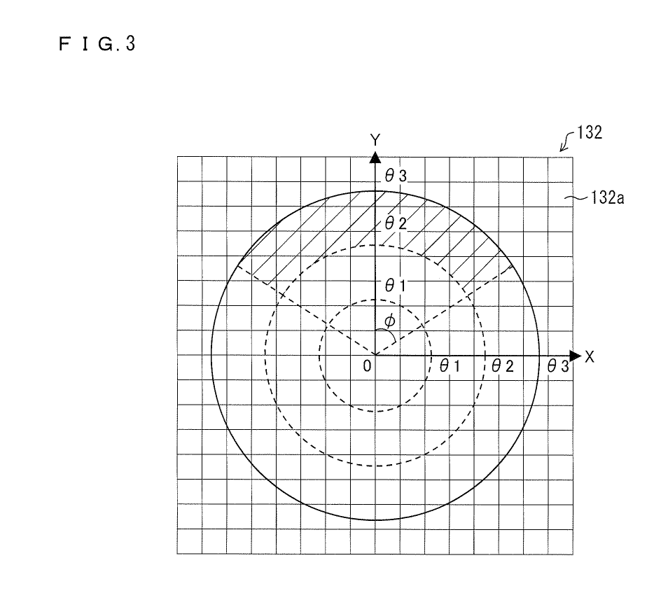

FIG. 3 is a diagram showing an example, an image of light having entered the image sensor 132 through the ultra wide-angle lens (fish-eye lens) 131, i.e., light received by the image sensor 132. The X and Y axes shown in FIG. 3 correspond to the X and Y axes of FIG. 2, respectively. The image sensor 132 has photoelectric converters (pixels) 132a, and light incident on the ultra wide-angle lens 131 (fish-eye lens) forms an image in a circle indicated by a solid line on the photoelectric converters 132a of the image sensor 132. That is, light incident on the ultra wide-angle lens 131 that corresponds to a polar-angle direction is taken an image of in a radial circular direction centering on the position of the principal point location (optical axis) of the ultra wide-angle lens 131. Since the ultra wide-angle lens 131 has an angle of view of 180 degrees (half-angle of view of 90 degrees), the polar angle θ3 of the outermost circumference (solid line in FIG. 3) of the radial circle is 90 degrees. The polar angle becomes smaller in the order of θ3, θ2, and θ1.

In this way, the angle of incidence of light incident on the glasses 10 can be specified by the coordinates of each pixel, namely each photoelectrical converter 132a.

It should be noted here that among the light incident to the ultra wide-angle lens 131 of the light reception detecting section 13, the range of light (necessary light) that affects the visual properties of the viewer is, for example, −60°≦φ≦60° and 60°≦θ≦90°. In FIG. 3, this range is indicated by diagonal lines. Defining this range of necessary light as such allows a computing range selecting section 232 in the display device main body 20 to, as will be described below, extract the pixels within the above range from detection signals (information associating the coordinates of each pixel and the intensity of light received on the coordinates with each other) generated by all of the pixels 132a of the image sensor 132. Then, on the basis of averaged luminance in this range, the luminance of the light source 24 can be controlled.

It should be noted that the range of necessary light described above is an example of the present invention, and the present invention is not limited thereto. This range of necessary light may be appropriately determined in accordance with the position of the light reception detecting section 13 located in the glasses 10, the light-receiving angle of the light-receiving lens, the position of the viewer with respect to the display device main body 20, the size of the display screen of a display panel 21, etc. The angle of direction φ and polar angle θ of light incident on the image sensor 132 change according to the positional relationship between the viewer wearing the glasses 10 and the display device main body relative to each other. Therefore, it is preferable that the range of necessary light be determined in consideration of the positions of the viewer and the display device main body relative to each other.

Further, it is preferable that the range of necessary light be determined according to the human field-of-view range. For example, the display-viewing angle envisioned by Ultra High Definition Television, which is a technology being developed by NHK (Nippon Hōsō Kyōkai), is a horizontal angle of view of ±50°. This range covers the induced field of view of humans. Therefore, it is preferable that the range of necessary light be a light-receiving range in which light within the induced field of view can be detected.

Meanwhile, the display device main body 20 includes: the display panel (display section) 21; the light source 24, which illuminates the display panel 21 from behind; a signal receiving section 22, which receives the digital signals (detection signals) from the signal transmitting section 14 of the glasses 10; and a luminance control section 23, which controls the luminance of the light source 24 in accordance with information obtained by the signal receiving section 22.

The display panel 21 displays a video picture based on video picture signals inputted thereto. A specific example of the display panel 21 includes a liquid crystal panel, etc. By displaying a video picture, the display panel 21 provides light from the video picture of the display device main body 20 to the glasses 10.

The light source 24 radiates light to the display panel 21. A specific example of the light source 24 includes a backlight that causes surface emission of light from fluorescent light tubes or from LEDs.

The signal receiving section 22 receives the detection signals from the signal transmitting section 14 of the glasses 10 as described above, and outputs the detection signals to the luminance control section 23.

The luminance control section 23 controls the luminance of the display panel 21 in accordance with the signals from the signal receiving section 22. As shown in FIG. 1, the luminance control section 23 includes a memory 231, the computing range selecting section 232, a field-of-view luminance computing section 233, a light source output computing section 234, and a light source output control section 235.

The memory 231 serves to temporarily store the signals (information) from the signal receiving section 22.

From the signals stored in the memory 231, the computing range selecting section 232 selects a necessary computing range in accordance with the information about the angle of incidence contained in the detection signals. That is, the computing range selecting section 232 (i) extracts, from the detection signals (image signals of the light incident on the glasses 10) generated by all of the photoelectric converters (pixels) 132a of the image sensor 132 of the glasses 10 shown in FIG. 3, pixels falling within the range of necessary light determined as described above, and (ii) inputs, to the field-of-view luminance computing section 233, detection signals corresponding to the pixels thus extracted.

It should be noted here that, for example, in such a case as a conventional one where a photodiode and a phototransistor are used as a sensor to detect the intensity of received light, the photodiode and the phototransistor detect the intensity of light from all directions in an averaged form. This makes it impossible to select, from the detection result, only the light from the direction of the display device main body (from a range of effective fields of view). This causes the field-of-view luminance computing section 233 to receive information about unnecessary light, thus making it impossible to control luminance appropriately for the viewer.

On the other hand, the present invention configures the light reception detecting section 13 in such a manner as described above to generate, as detection signals, information associating the angle of incidence of incident light and the intensity of the light at the angle of incidence with each other, and to transmit the information to the display device main body 20. Then, the computing range selecting section 232 in the display device main body 20 selects only a range of necessary angles of incidence (e.g., the range of effective fields of view) in accordance with the information about the angle of incidence contained in the detection signals (in the present embodiment, information about the coordinates of each pixel as detected by the image sensor 132), and identifies the range as a computing range.

Further, the field-of-view luminance computing section 233 calculates average luminance by averaging the intensities of received light as indicated by the detection signals within the computing range selected by the computing range selecting section 232, and outputs, as adaptation luminance, the average luminance thus calculated to the light source output computing section 234.

The adaptation luminance is luminance that is perceived by a viewer looking at the display panel 21 under the influence of the brightness of an area around the display 21. That is, in order to adapt to the intensity of light in the field-of-view range, the human eye perceives an object of the same luminance as varying in brightness (luminance) depending on the degree of brightness (luminance) to which the eye has adapted. In the present embodiment, as described above, the adaptation luminance Ys is calculated by averaging the luminance (intensities of received light) as indicated by the detection signals within the computing range selected as the range of effective fields of view. For the averaging procedure, a weighted mean may be used, or weight may be factored in prior to averaging the luminance.

The light source output computing section 234 calculates emission luminance (light source output) in accordance with the adaptation luminance calculated by the field-of-view luminance computing section 233.

The emission luminance of the light source can be calculated according to relational expression (1) as follows:

B=kY^{0.31}−(mYs^{0.31}+1) (1)

B: perceived brightness level; Y: object luminance (unit cd/m²); Ys: adaptation luminance (unit cd/m²); k, m, l: constants.

Relational expression (1) indicates that if the object luminance Y is controlled in accordance with the adaptation luminance Ys so that the perceived brightness level B is constant, the resulting luminance does not impair the viewer's visual perception. Here, the object luminance Y corresponds to the luminance of the light source 24 that illuminates the display panel 21.

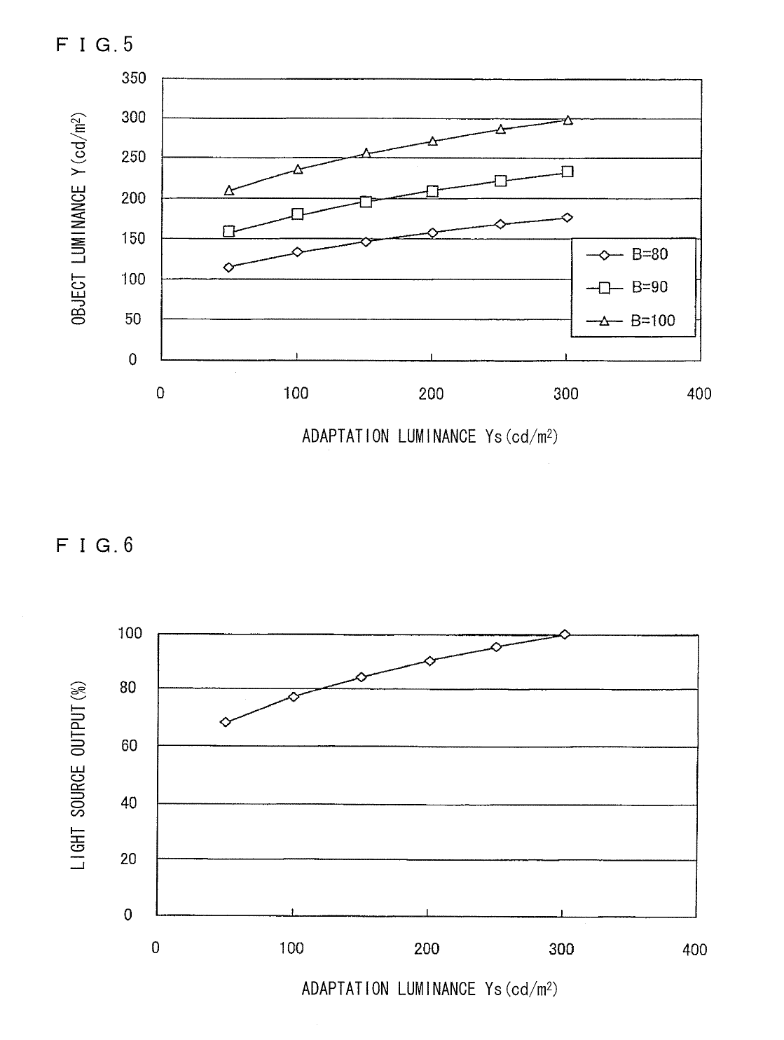

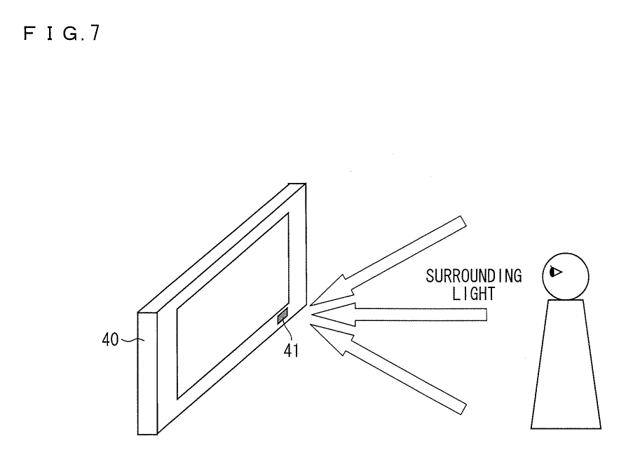

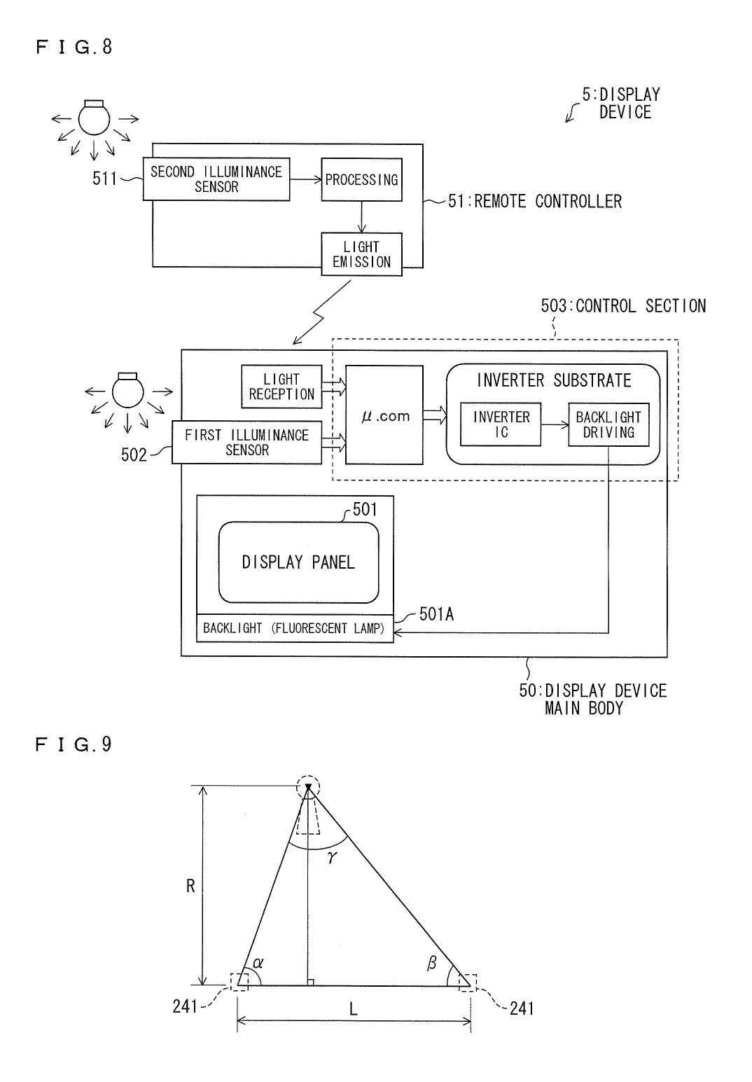

For example, when the constants are defined as k=23, m=5.62, and l=1.65, respectively, in relational expression (1), the relationship between the object luminance Y and the adaptation luminance Ys at which the perceived brightness level B is constant is defined as shown in FIG. 5. In FIG. 5, the horizontal axis represents the adaptation luminance, and the vertical axis represents the object luminance, with each perceived brightness level B at 80, 90, and 100, respectively.

FIG. 5 shows that if the adaptation luminance Ys increases, the visual properties of the viewer is kept intact, for example, by increasing the object luminance Y along the “perceived brightness level B=100” line. Further, the rate of change in the object luminance Y with respect to the adaptation luminance Ys stays substantially the same even if the perceived brightness level B changes. Accordingly, with attention focused on the rate of change in the object luminance Y, the luminance of the light source 24, which is the object luminance, is made to change at this rate of change with respect to a change in the adaptation luminance Ys. This relationship is shown in FIG. 6.

FIG. 6 shows the relationship of the light source output to the adaptation luminance Ys, with the horizontal axis representing the adaptation luminance Ys, and with the vertical axis representing the light source output (unit %). It should be noted here that the light source output is the luminance of the light source 24, and the light source luminance that is appropriate in a case where the adaptation luminance Ys is at its maximum (300 cd/m²) is calculated in advance from FIG. 5, with the light source output necessary for obtaining the light source luminance assumed to be 100%. The relationship between the adaptation luminance Ys and the light source output as shown in FIG. 6 is stored in the light source output control section 235 (see FIG. 1).

Then, in accordance with the adaptation luminance Ys calculated in advance and the object luminance Y calculated by the light source output computing section 234, the light source output control section 235 changes its output of electric power to be supplied to the light source 24, thereby appropriately controlling the luminance of the light source 24 (to be the object luminance thus calculated). This is how the display luminance of the display panel 21 can be controlled appropriately for the viewing environment in which the viewer is.

In the image display device of the present embodiment, as described above, the display panel 21 that the viewer is looking at carries out a display at an appropriate luminance for the brightness of the area around the display device main body 20. This saves the viewer from experiencing such discomfort as a feeling that the displaying panel 21 is displaying a screen image that is too bright or too dark to look at, thus achieving a reduction in the viewer's visual fatigue. Furthermore, the light source 24 does not become higher in luminance than necessary, so that a reduction in power consumption can be achieved.

Further, the distance between the display device main body 20 and the viewer is a key element for more appropriate control of the luminance of the display panel 21. Especially, in a case where there are a plurality of viewers, each viewer perceives a different intensity of light. This makes it difficult to appropriately control the surface luminance for all of the viewers at the same time.

For this reason, the present invention provides a distance detecting section that detects the distance between the display device main body 20 and each of the viewers, and determines control preference on the basis of a result of the detection. For example, with respect to the viewer who is closest to the display device main body 20, the display luminance of the display panel 21 is preferentially controlled by the method described above in accordance with the information from the glasses 10 worn by that viewer. Alternatively, the display luminance can be preferentially controlled with respect to the viewer who is furthest from the display device main body 20. Alternatively, the display luminance can be evenly controlled with respect to all of the viewers.

The phrase “preferentially controlled” here means that the display luminance of the display device is controlled in accordance with the detection signals from the glasses 10 worn by either the viewer who is closest to or the viewer who is furthest from the display device main body 20. Further, the phrase “evenly controlled” means that an average distance of all the distances between each viewer and the display device main body is detected, and that the display luminance of the display panel is controlled for an viewer located at the average distance from the display device main body.

A specific control object can be stored in advance in the memory 231 of the display device main body 20, and when the viewer requests control of the display luminance, the computing range selecting section 232 reads out an instruction therefor so that it can be used for selecting a computing range.

Detection of the distance between a viewer and the display device main body 20 can be achieved, for example, by providing infrared LEDs (signal emitting section, distance detecting section) in the display device main body 20. For example, such detection can be achieved by incorporating infrared LEDs 241 into left and right end sections of the display device main body 20 (see FIG. 2) and by capturing, with a sensor such as the image sensor 132 mounted in the glasses 10, signals emitted from the infrared LEDs 241. That is, in the present embodiment, the distance detecting section is constituted by the infrared LEDs 241 provided in the left and right end sections of the display device main body 20 and the image sensor 132 mounted in the glasses 10.

Then, data of the distance and display-viewing angle thus detected (distance data and display-viewing-angle data) need only be transmitted through the signal transmitting section 14 of the glasses 10 to the display device main body. The term “display-viewing angle” here means an angle from which the viewer looks at a screen of the display device main body 20. Therefore, by controlling the display luminance in consideration of the distance and the display-viewing angle, more appropriate control can be achieved than in a case, for example, where only the distance is taken into consideration.

A method for calculating the distance from a viewer to the display device main body is described here with reference to FIG. 9. First, the angles α and β from the infrared LEDs 241, incorporated in the left and right end sections of the front surface of the display device main body 20, to the viewer are calculated, respectively. The distance R from the viewer to the display device main body 20 calculated from the fixed distance L between the infrared LEDs 241 according to the principle of triangulation as represented relational expression (2) as follows:

R=L×(sin α+cos β)/sin(α−β) (2)

Also, as an example of a method for calculating the display-viewing angle γ, the display-viewing angle γ can be calculated according to relational expression (3) as follows:

γ=180°−α−β (3)

It should be noted that the example above is merely one example of a method for detecting the distance between an viewer and the display device main body 20, and the method is not limited to the example above as long as the method makes it possible detect/calculate the distance between a viewer and the display device main body 20 and the display-viewing angle of the viewer.

Next, methods for controlling the display luminance of the display panel in cases where a plurality of viewers are each wearing the glasses 10 are described.

A first method preferentially controls the display luminance with respect to the viewer who is closest to or furthest from the display device main body 20 among the plurality of viewers. According to this method, first, the distance detecting section detects the distance between the display device main body 20 and each of the viewers. That is, the image sensors 132 provided in the glasses 10 worn by each viewer detect infrared rays emitted from the infrared LEDs 241 of the display device main body 20, thereby generating the distance data. Next, in accordance with the distance data and the detection signals transmitted from the glasses 10 worn by each viewer to the display device main body 20, the luminance control section 23 in the display device main body 20 picks out the detection signals transmitted from the glasses 10 worn by either the viewer who is closest to or furthest from the display device main body 20. Then, in accordance with the detection signals thus picked out, the luminance of the light source 24 is controlled.

A second method evenly controls the display luminance with respect to all of the viewers. According to this method, there is no need to detect a distance as described above. The luminance control section 23 in the display device main body averages the detection signals transmitted from the glasses 10 worn by each viewer, and controls the luminance of the light source 24 in accordance with the detection signals thus averaged.

It should be noted that the image display system of the present invention uses conventional technologies for a signal input section, an image signal processing section, etc. that are necessary for displaying an image on the display panel 21 of the display device main body 20, and as such, these components are not described.

Further, the present invention can be applied to a 3D mechanism (e.g., a 3D image display device that comes with 3D glasses, etc.) which allows an image displayed on the display panel 21 to be perceived as a stereoscopic image. In this case, the display panel 21 in the display device main body 20 is a 3D display panel, and the glasses 10 are 3D glasses.

The human eyes, right and left, view an object from slightly different angles. This difference in the angles is called “parallax”, and when pictures of the object entering the right and left eyes are processed in the head (brain) to be a single image, an appearance of depth of space and a third dimensional appearance are felt. The 3D mechanism shows the right and left eyes video pictures taken from two different angles for the right and left eyes, respectively, thereby effecting perception as if there are an appearance of depth and a third dimensional appearance.

Examples of a method for viewing a stereoscopic image by wearing 3D glasses (viewing means) include (i) a method for displaying right and left images superimposed on each other and (ii) a method alternately displaying right and left images. The former is a method for attaching a 3D optical filter onto a display screen of a display device main body and viewing a stereoscopic image through the filter with polarized glasses, and the latter is a method for viewing a stereoscopic image with shutter glasses.

The former method is described by taking an Xpol method as an example. The Xpol method displays right-eye and left-eye video pictures alternately for each scanning line arranging fine circular polarizers on a surface of screen along the scanning lines, thereby displaying the right-eye and left-eye video pictures polarized. When viewed with 3D glasses using a circularly-polarizing filter, light from the even-numbered scanning lines enters the left eye and light from the odd-numbered scanning lines enters the right eye, whereby stereoscopic viewing is achieved.

The latter method is described by taking a frame sequential method as an example. The frame sequential method achieves stereoscopic viewing by a 3D image display device displaying 60 frames of a right-eye video picture and frames of a left-eye video picture per second (30 frames/sec. in the case of a typical image display device), thereby displaying a total of 120 frames, and by liquid crystal shutter glasses transmitting only the video pictures respectively corresponding to the right and left eyes. That is, the method achieves stereoscopic viewing by alternately displaying right-eye and left-eye video pictures.

Even in a case where such 3D glasses as those used in any of these method is used as the viewing means, control of the display luminance according to the visual properties of a viewer is achieved in the display device main body by transmitting information, to the display device main body, information (detection signals) obtained by detecting received light, as in the present embodiment.

The operation of the image display system of the present embodiment as described above is summarized with reference to FIG. 1 as follows: First, by operating the operation input section 11 provided in the glasses 10, the viewer decides whether or not to receive light from the display device main body 20 and from the area around the display device main body 20. If the operation input section 11 decides to receive light, the light reception control section 12 transmits, to the light reception detecting section 13, an instruction to detect light. Then, the intensity of the light thus received is detected by the light reception detecting section 13, and data of a result of the detection of the intensity of the light is transmitted by the signal transmitting section 14 to the display device main body 20.

Next, the display device main body 20 receives the signals from the signal transmitting section 14 of the glasses 10 through the signal receiving section 22. In accordance with the information obtained through the signal receiving section 22, the luminance control section 23 controls the luminance of the light source 24. It should be noted here that by providing the distance detecting section in the image display system, the distance from the viewer (glasses 10) to the display device main body 20 and the display-viewing angle can be taken into consideration as parameters for controlling the surface luminance of the display device main body. This makes it possible for the viewer to control the surface luminance appropriately for him/her at his/her option.

### Embodiment 2

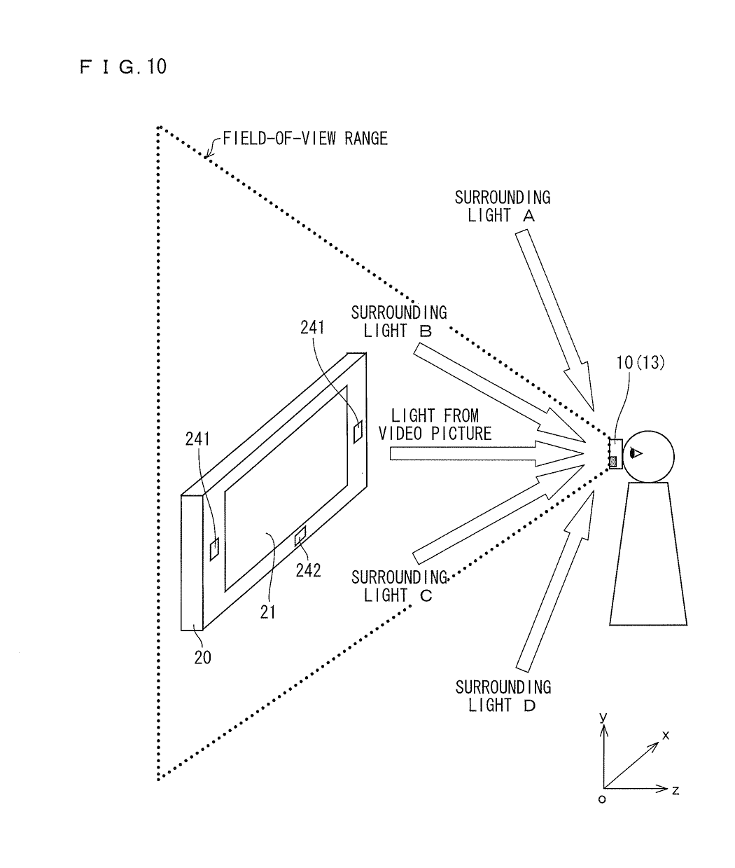

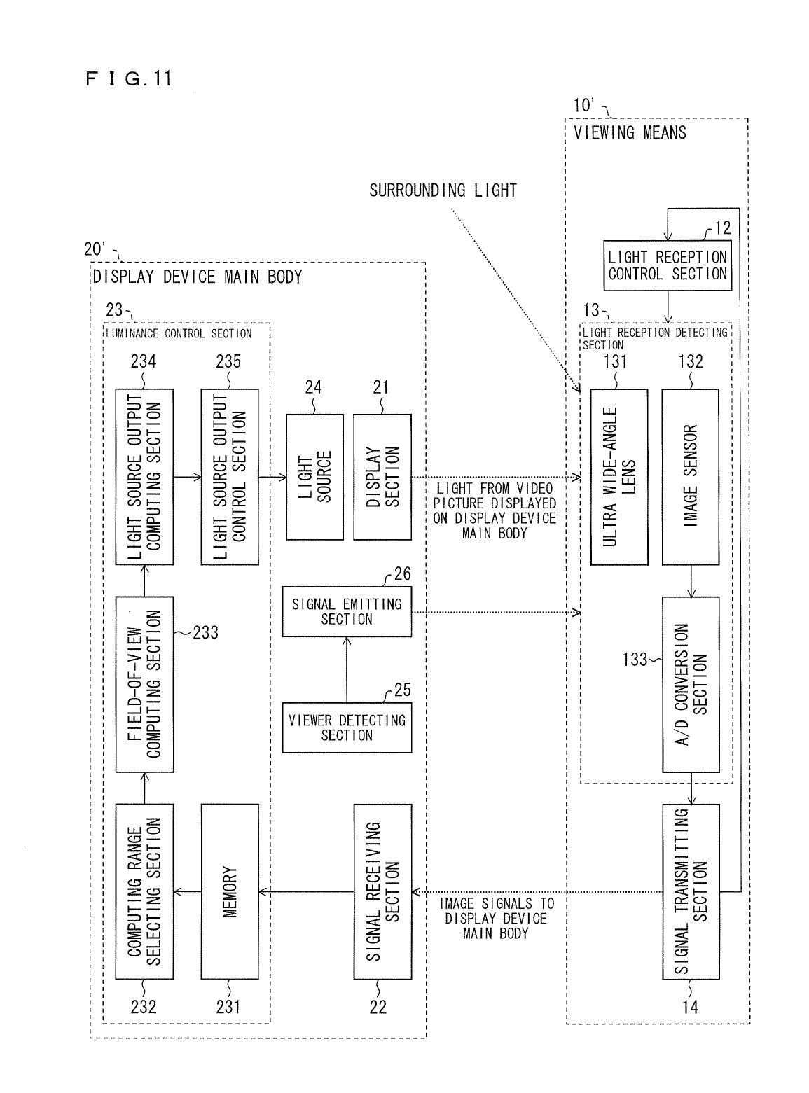

Another embodiment of an image display system according to the present invention is described below with reference to FIGS. 10 and 11. In the present embodiment, components having the same functions as those used in the embodiment above are given the same reference signs, and as such, are not described below.

FIG. 11 is a block diagram showing a configuration of a main part of an image display system according to another embodiment of the present invention. FIG. 10 is a diagram showing the appearance of a viewer looking at a display device main body with glasses (viewing means) shown in FIG. 11.

Unlike in the embodiment above, a display device main body 20′ in the present embodiment further includes: a viewer detecting section 25 such as a human detecting sensor; and a signal emitting section 26 such as infrared LEDs. Meanwhile, glasses 10′ are not provided with the operation input section 11 (see FIG. 1). As shown in FIG. 10, a human detecting sensor 242 constituting the viewer detecting section 25 and infrared LEDs 241 constituting the signal emitting section 26 are both provided on a front surface of the display device main body 20.

The viewer detecting section 25 needs only be provided on that side of the display device main body 20 on which a display screen is provided, but not on the display screen per se. The viewer detecting section 25 makes it possible to detect the presence or absence of a viewer within a detectable range in front of the display screen of the display device main body 20. It is desirable that the human detecting sensor have a wide-angle sensor for detection in a wide range in front of the display panel 21 (see FIG. 10).

When the viewer detecting section 25 detects a viewer, the viewer detecting section 25 instructs the signal emitting section 26 to emit a signal to the glasses 10′.

Upon receiving the instruction from the viewer detecting section 25, the signal emitting section 26 emits a signal to a sensor member such as the image sensor 132 of the light reception detecting section 13 of the glasses 10′. Then, the signal received by the image sensor 132 is converted by the A/D conversion section 133, and then is transmitted to the light reception control section 12, so that the light reception control section 12 gives an instruction to receive and detect light from the display device main body 20 and the area around the display device main body 20.

After that, as in the embodiment above, the light reception control section 12 gives the light reception detecting section 13 an instruction to detect the light, and the light reception detecting section 13 detects the intensity of the light received from the display device main body 20 and the area around the display device main body 20. Then, data of a result of the detection of the intensity of the light is transmitted as signals to the display device main body 20 through the signal transmitting section 14. The display device main body 20 receives the signals from the signal transmitting section 14 of the glasses 10 through the signal receiving section 22. In accordance with the information (signals) obtained through the signal receiving section 22, the luminance control section 23 controls the luminance of the light source 24.

Of course, in the present embodiment, too, the distance from the viewer (glasses 10′) to the display device main body 20′ and the display-viewing angle can be taken into consideration as parameters for controlling the surface luminance of the display device main body. For example, when the viewer detecting section 25 detects the viewer, the signal emitting section 26 (such as infrared LEDs) emits a signal for detecting the distance and the display-viewing angle. Then, by capturing the emitted signal with a sensor member such as the image sensor 132 as described above, the distance between the viewer (glasses 10′) and the display device main body 20′ and the display-viewing angle can be detected. This makes it possible to control the surface luminance appropriately for the viewer.

In the present embodiment, as described above, by detecting a viewer with the viewer detecting section 25 without providing the operation input section 11 (see FIG. 1), which is not included in the glasses 10′ in the present embodiment (as shown in FIG. 11), a series of operations for controlling the surface luminance is automatically carried out. That is, the present embodiment makes it possible to automatically control the surface luminance appropriately for the viewer, without requiring the viewer's operation.

It should be noted that the method for controlling surface luminance, the method for calculating the distance between a viewer (glasses 10′) and the display device main body 20′ and for calculating a display-viewing angle, and the method for controlling surface luminance in a case where a plurality of viewers are each wearing the glasses 10′, etc. are the same as those described above in Embodiment 1.

Although, in the embodiment above, the viewing means has been described by taking glasses as an example, the viewing means of the present invention is not particularly limited as long as it is used in viewing a video picture displayed on the display section of the display device main body.

The present invention can also be expressed as follows:

The image display system of the present invention is preferably configured such that: the light reception detecting section generates, as the detection signals, information associating an angle of incidence of the incident light and the intensity of the light at the angle of incidence with each other; the luminance control section includes (i) a computing range selecting section that selects a computing range from among the detection signals in accordance with the information about the angle of incidence contained in the detection signal and (ii) a field-of-view luminance computing section that calculates average luminance in the computing range thus selected and outputs, as adaptation luminance, the average luminance thus calculated; and the luminance control section controls the luminance of the light source in accordance with the adaptation luminance.

The term “angle of incidence of the incident light” here means the angle of incidence of light incident on a light-receiving surface of the light reception detecting section.

According to the foregoing configuration, the information about the angle of incidence of the incident light is contained in the detection signals generated by the light reception detecting section, so that in accordance with the angle of incidence indicated by the detection signals transmitted, the computing range selecting section can pick out, from among all of the detection signals, a detection signal to be used for the computation. For example, the computing range selecting section can select, as predetermined signals, detection signals (result of the detection of light intensity) representing light (light from the necessary range) coming from within the field-of-view range of the viewer looking at the display section.

Furthermore, the field-of-view computing section calculates average luminance by averaging the result of the detection of light intensity contained in each of the detection signals thus selected, and outputs the average luminance as adaptation luminance. That is, the field-of-view computing section calculates the average luminance of the light from within the necessary range (range within which the visual properties of the viewer is affected), thus obtaining, as the adaptation luminance, accurate luminance corresponding to the field-of-view range of the viewer. Then, in accordance with the adaptation luminance thus obtained, the luminance of the light source is controlled.

Therefore, the foregoing configuration makes it possible to control the emission luminance of the light source in accordance with the accurate luminance corresponding to the visual properties of the viewer, thus achieving an appropriate image display for the viewing environment in which the viewer is.

Further, the image display system is preferably configured such that the computing range selected from among the detection signals contains at least detection signals representing light coming from a direction of the display device main body.

The foregoing configuration makes it possible to incorporate, into the computing range, the light coming from the direction of the display device main body, which light greatly affect the visual properties of the viewer.

Further, the image display system may be configured to further include a distance detecting section that detects a distance between the display device main body and the viewer. The distance detecting section is constituted by (i) a signal emitting section provided in the display device main body and (ii) a signal receiving section provided in the viewing means.

The foregoing configuration makes it possible to detect the distance between the display device main body and the viewer.

Further, the image display system may be configured such that in a case where the viewer comprises a plurality of viewers each wearing the viewing means, the distance detecting section detects a distance between the viewing means worn by each of the viewers and the display device main body, and the luminance control section controls the luminance of the light source in accordance with detection signals from the viewing means located (i) closest to the display device main body, (ii) furthest from the display device main body, or (iii) at an average distance from the display device main body.

The foregoing configuration makes it possible, in a case where there are a plurality of viewers, to control the luminance of the light source luminance with reference to the viewer who is in a place (i) closest to the display device main body, (ii) furthest from the display device main body, or (iii) in the middle among these places (at the average distance).

Alternatively, the image display system may be configured such that in a case where the viewer comprises a plurality of viewers each wearing the viewing means, the luminance control section controls the luminance of the light source by averaging the detection signals obtained from all of the viewing means.

The foregoing configuration makes it possible, in a case where there are a plurality of viewers, to control the luminance of the light source luminance by averaging the visual properties of each of the viewers.

Further, the image display system is preferable configured such that the light reception detecting section includes (i) a wide-angle lens or an ultra wide-angle lens and (ii) a sensor member that detects an intensity of incident light and an angle of incidence.

The configuration allows the sensor member to receive light from a wide angle of view through the light-receiving lens, thus making it possible to more accurately detect the light intensity of the viewing environment in which the viewer is.

It should be noted that in the case of the ultra wide-angle lens, the light reception detecting section can receive surrounding light from an angle of view of 180 degrees.

Further, the image display system is preferably configured such that: the ultra wide-angle lens is a fish-eye lens; and the sensor member is an image sensor.

According to the foregoing configuration, since the ultra wide-angle lens is a fish-eye lens, light from a very wide angle of view can be received. Further, since the intensity of light is detected by the image sensor, the intensity of light can be detected for each direction (angle of incidence) from which the light comes. Further, outputs (detection signals) corresponding to the intensity of light as detected by the image sensor are outputted from each separate pixel of the image sensor. Therefore, outputs necessary for luminance computation can be easily obtained by extracting outputs from only pixels falling within the range selected by the computing range selection section.

Further, the image display system is preferably configured such that the display device main body further includes (i) a viewer detecting section that detects the presence of a viewer and (ii) a signal emitting section that emits a signal to the viewing means at an instruction from the viewer detecting section.

According to the foregoing configuration, by the result of the viewer detecting section having detected the presence of a viewer, the signal emitting section emits a signal to the viewing means, so that the reception of light by the viewing means is determined. Therefore, surface luminance can be automatically controlled.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to an image display device, such as a television receiver and a computer device, which is illuminated by a light source.

### REFERENCE SIGNS LIST

10 Glasses (viewing means)
11 Operation input section
12 Light reception control section
13 Light reception detecting section
131 Ultra wide-angle lens
132 Image sensor (signal receiving section, distance detecting section)
133 A/D conversion section
14 Signal transmitting section
20 Display device main body
21 Display panel (display section)
22 Signal receiving section
23 Luminance control section
231 Memory
232 Computing range selecting section
233 Field-of-view luminance computing section
234 Light source output computing section
235 Light source output control section
241 Infrared LED (signal emitting section, distance detecting section)
242 Human detecting sensor (distance detecting section)
24 Light source

1. An image display system comprising:
a display device main body having a display section and a light source that irradiates the display section with light; and
viewing means that a viewer is able to wear in viewing a video picture displayed on the display section,
the viewing means including (i) a light reception detecting section that detects an intensity of incident light and (ii) a signal transmitting section that transmits, to the display device main body, detection signals obtained by the light reception detecting section detecting the intensity of the incident light,
the display device main body including a luminance control section that controls a luminance of the light source in accordance with the detection signals.

2. The image display system as set forth in claim 1, wherein:
the light reception detecting section generates, as the detection signals, information associating an angle of incidence of the incident light and the intensity of the light at the angle of incidence with each other;
the luminance control section includes (i) a computing range selecting section that selects a computing range from among the detection signals in accordance with the information about the angle of incidence contained in the detection signal and (ii) a field-of-view luminance computing section that calculates average luminance in the computing range thus selected and outputs, as adaptation luminance, the average luminance thus calculated; and
the luminance control section controls the luminance of the light source in accordance with the adaptation luminance.

3. The image display system as set forth in claim 2, wherein the computing range selected from among the detection signals contains at least detection signals representing light coming from a direction of the display device main body.

4. The image display system as set forth in claim 2, further comprising a distance detecting section that detects a distance between the display device main body and the viewer, the distance detecting section being constituted by (i) a signal emitting section provided in the display device main body and (ii) a signal receiving section provided in the viewing means.

5. The image display system as set forth in claim 4, wherein in a case where the viewer comprises a plurality of viewers each wearing the viewing means, the distance detecting section detects a distance between the viewing means worn by each of the viewers and the display device main body, and the luminance control section controls the luminance of the light source in accordance with detection signals from the viewing means located (i) closest to the display device main body, (ii) furthest from the display device main body, or (iii) at an average distance from the display device main body.

6. The image display system as set forth in claim 1, wherein in a case where the viewer comprises a plurality of viewers each wearing the viewing means, the luminance control section controls the luminance of the light source by averaging the detection signals obtained from all of the viewing means.

7. The image display system as set forth in claim 1, wherein the light reception detecting section includes (i) a wide-angle lens or an ultra wide-angle lens and (ii) a sensor member that detects an intensity of incident light and an angle of incidence.

8. The image display system as set forth in claim 7, wherein:
the ultra wide-angle lens is a fish-eye lens; and
the sensor member is an image sensor.

9. The image display system as set forth in claim 4, wherein the display device main body further includes (i) a viewer detecting section that detects the presence of a viewer and (ii) a signal emitting section that emits a signal to the viewing means at an instruction from the viewer detecting section.

10. The image display system as set forth in claim 6, wherein the display device main body further includes (i) a viewer detecting section that detects the presence of a viewer and (ii) a signal emitting section that emits a signal to the viewing means at an instruction from the viewer detecting section.

11. The image display system as set forth in claim 7, wherein the display device main body further includes (i) a viewer detecting section that detects the presence of a viewer and (ii) a signal emitting section that emits a signal to the viewing means.
